(19) United States
(12) Patent Application Publication
(10) Pub. No.: US 2015/0264422 A1
(43) Pub. Date: Sep. 17, 2015

(54) Terminal Remote Control Method, Set Top Box, Mobile Terminal, and Web Page Server

(71) Applicant: HUAWEI TECHNOLOGIES CO., LTD., Shenzhen (CN)

(72) Inventor: Heming Wang, Shanghai (CN)

(21) Appl. No.: 14/660,483

(22) Filed: Mar. 17, 2015

(30) Foreign Application Priority Data
Mar. 17, 2014 (CN) 201410098840.6

(51) Int. Cl. H04N 21/422; H04N 21/41; H04N 21/81; H04M 1/725

(52) U.S. Cl. CPC H04N 21/4222; H04M 1/72533; H04M 1/72561; H04N 21/4126; H04N 21/42221; H04N 21/42219; H04N 21/42208; H04N 21/8173; H04N 21/8186

(57) ABSTRACT

A terminal remote control method, including sending, by a set top box, application information to a mobile terminal, where the application information is used to instruct the mobile terminal to acquire, using a web page server, a control user interface (UI) for remote control on the set top box, the application information carries address information of the control UI and connection information that is required by the mobile terminal for establishing a connection to the set top box using the web page server; receiving, by the set top box, an operation instruction that is sent by the mobile terminal on the control UI using the web page server; and performing, by the set top box, an operation according to the operation instruction. Therefore, a remote control operation performed by the mobile terminal on the set top box is implemented.

### CROSS-REFERENCE TO RELATED APPLICATION

This application claims priority to Chinese Patent Application No. 201410098840.6, filed on Mar. 17, 2014, which is hereby incorporated by reference in its entirety.

### TECHNICAL FIELD

Embodiments of the present invention relate to communications technologies, and in particular, to a terminal remote control method, a set top box, a mobile terminal, and a web page server.

### BACKGROUND

With development of science and technology, people can perform remote control on a set top box or a television using a handheld terminal, such as a mobile phone.

In the prior art, a set top box of a television performs screen capturing on video content of the television, a handheld terminal acquires the video content, and a remote control unit of a remote control system in the handheld terminal decodes the video content to obtain a decoding stream, and then the handheld terminal analyzes the decoding stream and generates a television control interface on the handheld terminal, so as to perform operation on the television.

However, in the prior art, the terminal at least has functions of decoding video content and performing real-time information processing, and therefore, a low-end terminal without these functions cannot perform remote control on a television or a set top box.

### SUMMARY

Embodiments of the present invention provide a terminal remote control method, a set top box, a mobile terminal and a web page server, so as to solve a problem that a low-end terminal performs remote control on a television or a set top box.

A first aspect of the embodiments of the present invention provides a terminal remote control method, including sending, by a set top box, application information to a mobile terminal, where the application information is used to instruct the mobile terminal to acquire, using a web page server, a control user interface (UI) for remote control on the set top box, the application information carries address information of the control UI and connection information that is required by the mobile terminal for establishing a connection to the set top box using the web page server, and the application information is information edited using a web page description language; receiving, by the set top box, an operation instruction that is sent by the mobile terminal on the control UI using the web page server; and performing, by the set top box, an operation according to the operation instruction.

In a first possible implementation manner, before the sending, by a set top box, application information to a mobile terminal, the method further includes generating, by the set top box, the control UI using a web page description language; and sending, by the set top box, information about the control UI to the web page server, so as to enable the web page server to provide the control UI for the mobile terminal.

With reference to the first aspect or the first possible implementation manner of the first aspect, in a second possible implementation manner, the set top box sends the application information to the mobile terminal in a broadcast manner.

With reference to any one of the first aspect to the second possible implementation manner of the first aspect, in a third possible implementation manner, after the sending, by a set top box, application information to a mobile terminal, the method further includes sending, by the set top box, an application update message to the mobile terminal, where the application update message is used to update at least one of the address information of the control UI and the connection information.

A second aspect of the embodiments of the present invention provides a terminal remote control method, including receiving, by a mobile terminal, application information sent by a set top box, where the application information is used to instruct the mobile terminal to obtain, using a web page server, a control UI for remote control on the set top box, the application information carries address information of the control UI and connection information that is required by the mobile terminal for establishing a connection to the set top box using the web page server, and the application information is information edited using a web page description language; establishing, by the mobile terminal according to the connection information, the connection to the set top box using the web page server; and sending, by the mobile terminal according to the address information of the control UI and on the control UI, an operation instruction to the set top box using the web page server.

In a first possible implementation manner, after the receiving, by a mobile terminal, application information sent by a set top box, the method further includes receiving, by the mobile terminal, an application update message sent by the set top box, where the application update message is used to update at least one of the address information of the control UI and the connection information.

In the second aspect or the first possible implementation manner, in a second possible implementation manner, the sending, by the mobile terminal according to the address information of the control UI and on the control UI, an operation instruction to the set top box using the web page server includes acquiring, by the mobile terminal after receiving the application information sent by the set top box, the control UI using the web page server, and sending, on the control UI, the operation instruction to the set top box using the web page server, where the control UI is used for remote control on the set top box.

A third aspect of the embodiments of the present invention provides a set top box, including a sending module configured to send application information to a mobile terminal, where the application information is used to instruct the mobile terminal to acquire, using a web page server, a control UI for remote control on the set top box, and the application information carries address information of the control UI and connection information that is required by the mobile terminal for establishing a connection to the set top box using the web page server; a receiving module configured to receive an operation instruction that is sent by the mobile terminal on the control UI using the web page server; and a processing module configured to perform an operation according to the operation instruction.

In a first possible implementation manner, the processing module is further configured to generate the control UI using a web page description language; and the sending module is further configured to send information about the control UI to the web page server, so as to enable the web page server to provide the control UI for the mobile terminal.

With reference to the third aspect or the first possible implementation manner of the third aspect, in a second possible implementation manner, the sending module is further configured to send the application information to the mobile terminal in a broadcast manner.

With reference to any one of the third aspect to the second possible implementation manner of the third aspect, in a third possible implementation manner, the sending module is further configured to send an application update message to the mobile terminal, where the application update message is used to update at least one of the address information of the control UI and the connection information.

A fourth aspect of the embodiments of the present invention provides a mobile terminal, including a receiving module configured to receive application information sent by a set top box, where the application information is used to instruct the mobile terminal to obtain, using a web page server, a control UI for remote control on the set top box, and the application information carries address information of the control UI and connection information that is required by the mobile terminal for establishing a connection to the set top box using the web page server; and a processing module configured to establish, based on the connection information, the connection to the set top box using the web page server; and send, on the control UI according to the address information of the control UI, an operation instruction to the set top box using the web page server.

In a first possible implementation manner, the receiving module is further configured to receive an application update message sent by the set top box, where the application update message is used to update at least one of the address information of the control UI and the connection information.

In the fourth aspect or the first possible implementation manner, in a second possible implementation manner, the mobile terminal further includes a sending module, where the sending module is configured to, after the application information sent by the set top box is received, acquire, using the web page server, the control UI for remote control on the set top box, and send, on the control UI, the operation instruction to the set top box using the web page server.

A fifth aspect of the embodiments of the present invention provides a terminal remote control method, including receiving, by a web page server, application information that is sent by a set top box to a mobile terminal, and forwarding the application information to the mobile terminal, where the application information is used to instruct the mobile terminal to acquire, using the web page server, a control UI for remote control on the set top box, the application information carries address information of the control UI and connection information that is required by the mobile terminal for establishing a connection to the set top box using the web page server, and the application information is information edited using a web page description language; providing, by the web page server, the control UI for the mobile terminal; and receiving, by the web page server, an operation instruction that is sent by the mobile terminal on the control UI, and forwarding the operation instruction to the set top box.

In a first possible implementation manner, before the receiving, by a web page server, application information that is sent by a set top box to a mobile terminal, the method further includes receiving, by the web page server, information about the control UI sent by the set top box; and the providing, by the web page server, the control UI for the mobile terminal includes providing, by the web page server, the control UI for the mobile terminal according to the information about the control UI.

In the fifth aspect or the first possible implementation manner, in a second possible implementation manner, after the receiving, by a web page server, application information that is sent by a set top box to a mobile terminal, and forwarding the application information to the mobile terminal, the method further includes receiving, by the web page server, an application update message sent by the set top box, and forwarding the application update message to the mobile terminal, where the application update message is used to update at least one of the address information of the control UI and the connection information.

A sixth aspect of the embodiments of the present invention provides a web page server, including a sending module configured to receive application information that is sent by a set top box to a mobile terminal, and forward the application information to the mobile terminal, where the application information is used to instruct the mobile terminal to acquire, using the web page server, a control UI for remote control on the set top box, the application information carries address information of the control UI and connection information that is required by the mobile terminal for establishing a connection to the set top box using the web page server, and the application information is information edited using a web page description language; a processing module configured to provide the control UI for the mobile terminal; and a receiving module configured to receive an operation instruction that is sent by the mobile terminal on the control UI, and forward the operation instruction to the set top box.

In a first possible implementation manner, the receiving module is further configured to receive information about the control UI sent by the set top box; and the processing module is configured to provide the control UI for the mobile terminal according to the information about the control UI.

In the sixth aspect or the first possible implementation manner, in a second possible implementation manner, the sending module is further configured to receive an application update message sent by the set top box, and forward the application update message to the mobile terminal, where the application update message is used to update at least one of the address information of the control UI and the connection information.

According to the terminal remote control method, the set top box, the mobile terminal, and the web page server provided in the present invention, a set top box sends application information to a mobile terminal, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; the set top box receives an operation instruction that is sent by the mobile terminal on the control UI using the web page server; and then the set top box performs an operation according to the operation instruction. Therefore, a remote control operation performed by the mobile terminal on the set top box is implemented, and the mobile terminal merely needs to parse information edited in a web page description language, but does not need to decode video content of a television, which has a relatively low requirement for the mobile terminal, thereby implementing remote control on a set top box using a low and middle-end smart mobile terminal.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show some embodiments of the present invention, and persons of ordinary skill in the art may still derive other drawings from these accompanying drawings without creative efforts.

FIG. 1 is a schematic flowchart of a terminal remote control method according to an embodiment of the present invention;

FIG. 2 is a schematic flowchart of another terminal remote control method according to an embodiment of the present invention;

FIG. 3 is a schematic flowchart of still another terminal remote control method according to an embodiment of the present invention;

FIG. 4 is a schematic structural diagram of a set top box according to an embodiment of the present invention;

FIG. 5 is a schematic structural diagram of a mobile terminal according to an embodiment of the present invention;

FIG. 6 is a schematic structural diagram of another mobile terminal according to an embodiment of the present invention;

FIG. 7 is a schematic flowchart of yet another terminal remote control method according to an embodiment of the present invention;

FIG. 8 is a schematic structural diagram of a web page server according to an embodiment of the present invention; and

FIG. 9 is a schematic structural diagram of another mobile terminal according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. The described embodiments are a part rather than all of the embodiments of the present invention. All other embodiments obtained by persons of ordinary skill in the art based on the embodiments of the present invention without creative efforts shall fall within the protection scope of the present invention.

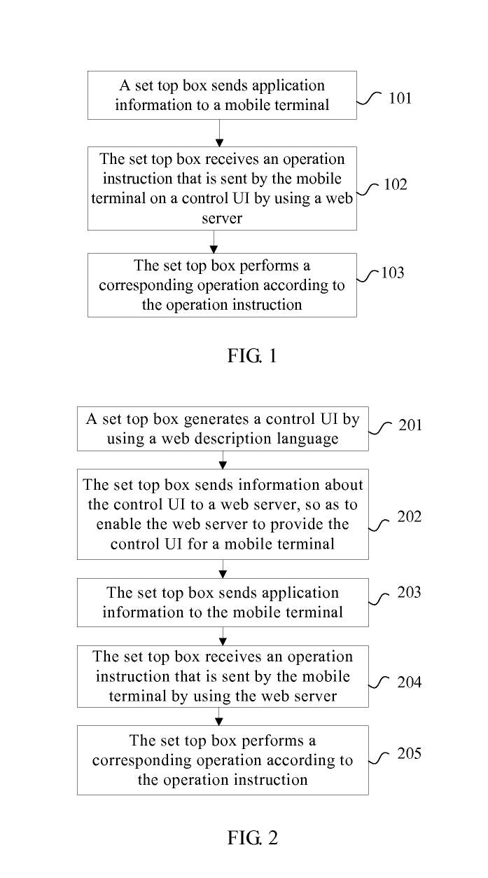

FIG. 1 is a schematic flowchart of a terminal remote control method according to an embodiment of the present invention. As shown in FIG. 1, the terminal remote control method includes the following steps:

Step 101: A set top box sends application information to a mobile terminal.

After the set top box is started, the set top box may send the application information to the mobile terminal. For example, after the set top box is started, the set top box may send the application information to all networked mobile terminals in a home local area network in a broadcast manner, where the application information is information edited using a web page description language. For example, the application information is information edited by the set top box using a Hypertext Markup Language, such as HTML.5, or the application information is information edited by the set top box using an Extensible Markup Language, such as XML.

In this embodiment, the application information is used to instruct the mobile terminal to acquire, using a web page server, a control UI for remote control on the set top box, where the control UI may include operation buttons for performing fast forwarding, pausing, replaying, and the like on the set top box. The application information carries address information of the control UI and connection information that is required by the mobile terminal for establishing a connection to the set top box using the web page server, where the mobile terminal may be a smartphone, a handheld computer, or the like.

It should be noted that the set top box may send the application information to the mobile terminal in a broadcast manner, that is, a broadcast server may be additionally disposed in an existing set top box, so that the set top box broadcasts the application information to the mobile terminal.

For example, the set top box may send the application information to all networked mobile terminals in a home local area network using Internet Protocol version 4 (IPv4) or IPv6. To broadcast the application information, the set top box may send a message to an address 224.0.0.1 in an IPv4 scenario, and send a message to ff02::1 in an IPv6 scenario.

Step 102: The set top box receives an operation instruction that is sent by the mobile terminal on a control UI using a web page server.

Step 103: The set top box performs an operation according to the operation instruction.

For example, the operation instruction is a pause instruction, after receiving the instruction sent by the mobile terminal, the set top box performs a pausing operation on a television connected to the set top box.

In this embodiment, a set top box sends application information to a mobile terminal, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; the set top box receives an operation instruction that is sent by the mobile terminal on the control UI using the web page server, and then the set top box performs an operation according to the operation instruction. Therefore, a remote control operation performed by the mobile terminal on the set top box is implemented, and the mobile terminal only needs to parse information edited using a web page description language, but does not need to decode video content of a television, which has a relatively low requirement for the mobile terminal, thereby implementing remote control on a set top box using a low and middle-end smart mobile terminal.

FIG. 2 is a schematic flowchart of another terminal remote control method according to an embodiment of the present invention. As shown in FIG. 2, the terminal remote control method includes the following steps:

Step 201: A set top box generates a control UI using a web page description language.

After the set top box is started, the set top box may generate the control UI using the web page description language. It should be noted that if in a last startup process, the set top box has generated a UI and temporarily stored the UI in the set top box, the set top box may not generate a UI in a current startup process but directly performs step 202.

The set top box generates the control UI using the web page description language. For example, if an Android application system is configured for the set top box, the Android application system may construct a corresponding UI under HTML.5 according to need, namely, a function of the set top box.

Step 202: The set top box sends information about the control UI using a web page server, so as to enable the web page server to provide the control UI for a mobile terminal.

In this embodiment, the web page server is a network element that forwards an operation instruction to the mobile terminal, where the operation instruction is sent by the set top box.

Step 203: The set top box sends application information to the mobile terminal.

In this embodiment, the application information is information edited using the web page description language, for example, the application information is information edited by the set top box using a Hypertext Markup Language, such as HTML.5, or information edited by the set top box using an Extensible Markup Language, such as XML. The application information is used to instruct the mobile terminal to acquire the control UI for remote control on the set top box. The application information carries address information of the control UI, and information that is required for establishing a connection to the set top box, and the mobile terminal may be a smartphone, a handheld computer, or the like.

For example, the set top box may send the application information to all networked mobile terminals in a home local area network using IPv4 or IPv6. To broadcast the application information, the set top box may send a message to an address 224.0.0.1 in an IPv4 scenario, and send a message to ff02::1 in an IPv6 scenario.

It should be noted that a sequence of step 202 and step 203 is not limited in this embodiment.

Step 204: The set top box receives an operation instruction that is sent by the mobile terminal using the web page server.

Step 205: The set top box performs a corresponding operation according to the operation instruction.

In this embodiment, the set top box automatically generates the control UI using the web page description language, that is, the set top box may generate, according to a function of the set top box, the control UI. Therefore, it is implemented that a user performs remote control on the set top box using the mobile terminal more conveniently.

Further, on a basis of the foregoing embodiment, the terminal remote control method may further include the set top box sends an application update message to the mobile terminal, where the application update message is used to update at least one of the address information of the control UI and the connection information.

When an application system of the set top box changes, a new control UI needs to be generated. For example, when the Android application system of the set top box changes, the Android application system may send a new control UI update message through a broadcast channel, so as to update the control UI of the set top box on the mobile terminal.

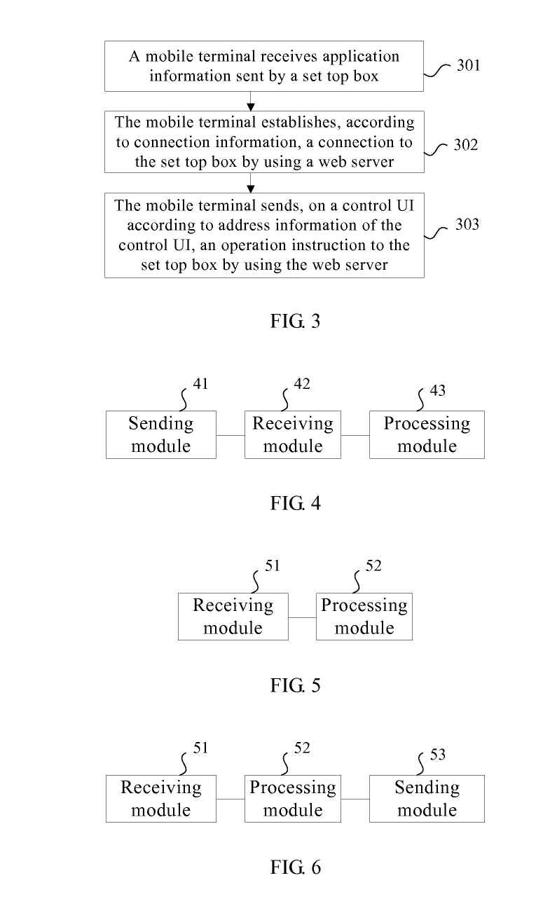

FIG. 3 is a schematic flowchart of still another terminal remote control method according to an embodiment of the present invention. As shown in FIG. 3, the terminal remote control method includes the following steps:

Step 301: A mobile terminal receives application information sent by a set top box.

In this embodiment, the application information is used to instruct the mobile terminal to obtain, using a web page server, a control UI for remote control on the set top box, where the application information carries address information of the control UI and connection information that is required by the mobile terminal for establishing a connection to the set top box using the web page server, and the application information is information edited using a web page description language.

Step 302: The mobile terminal establishes, according to connection information, a connection to the set top box using a web page server.

The mobile terminal establishes, according to the connection information, namely, the information that is required for establishing the connection to the set top box by the mobile terminal using the web page server, the connection to the set top box using the web page server.

Step 303: The mobile terminal sends, on the control UI according to address information of a control UI, an operation instruction to the set top box using the web page server.

For example, the mobile terminal needs to monitor broadcast information. When receiving the application information sent by the set top box in a broadcast manner, the mobile terminal may parse information about the control UI in the application information, for example, parse HTML.5 web page information, and then send the HTML.5 web page information to an HTML.5 browser. Therefore, the HTML.5 browser establishes a connection to the set top box and communicates, so that it may be implemented that the mobile terminal sends control information to the set top box.

In this embodiment, the mobile terminal is only required to have functions of monitoring and parsing the broadcast information, so there is no additional requirement for the mobile terminal on decoding video content and performing real-time information processing. Therefore, a developer may develop a universal iPhone Operating System (IOS) and a universal Android application for a mobile terminal to perform downloading.

Further, on a basis of the foregoing embodiment, after step 301, the terminal remote control method may further include the mobile terminal receives an application update message sent by the set top box, where the application update message is used to update at least one of the address information of the control UI and the connection information.

The application information carries information about the connection to the set top box, where the connection information includes the address information of the set top box, and configuration information that is used by the mobile terminal to establishing the connection to the set-top box. Therefore, the mobile terminal may establish, on a web page, a Transmission Control Protocol (TCP) connection to the set top box using WebSocket (namely, a web page server).

The mobile terminal sends an operation instruction to the set top box using the web page server, so as to enable the set top box to perform an operation according to the operation instruction.

It should be noted that, in the foregoing embodiment, the set top box generates the control UI using a web page description language. For example, the set top box constructs a corresponding UI under HTML.5 according to a function of the set top box, and may also construct an XML file that is edited using XML. That is, the mobile terminal has functions of parsing and displaying XML, and then remote control on the set top box may be implemented.

On a basis of the foregoing embodiment, after receiving the application information sent by the set top box, the mobile terminal acquires, using the web page server, the control UI for the remote control on the set top box, and sends, on the control UI, the operation instruction to the set top box using the web page server.

FIG. 4 is a schematic structural diagram of a set top box according to an embodiment of the present invention. As shown in FIG. 4, the set top box includes a sending module 41, a receiving module 42 and a processing module 43, where the sending module 41 is configured to send application information to a mobile terminal, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; the receiving module 42 is configured to receive an operation instruction that is sent by the mobile terminal on the control UI using the web page server; and the processing module 43 is configured to perform an operation according to the operation instruction.

In this embodiment, a set top box sends application information to a mobile terminal, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; the set top box receives an operation instruction that is sent by the mobile terminal on the control UI using the web page server; and then the set top box performs an operation according to the operation instruction. Therefore, a remote control operation performed by the mobile terminal on the set top box is implemented, and the mobile terminal only needs to parse information edited using a web page description language, but does not need to decode video content of a television, which has a relatively low requirement for the mobile terminal, thereby implementing remote control on a set top box using a low and middle-end smart mobile terminal.

On a basis of the foregoing embodiment, the processing module 43 is further configured to generate the control UI using a web page description language.

The sending module 41 is further configured to send information about the control UI to the web page server, so as to enable the web page server to provide the control UI for the mobile terminal.

Further, on the basis of the foregoing embodiment, the sending module 41 is further configured to send the application information to the mobile terminal in a broadcast manner.

On the basis of the foregoing embodiment, the sending module 41 is further configured to send an application update message to the mobile terminal, where the application update message is used to update at least one of the address information of the control UI and the connection information.

For a specific function of each module in the set top box, reference may be made to description of the foregoing method embodiments.

FIG. 5 is a schematic structural diagram of a mobile terminal according to an embodiment of the present invention. As shown in FIG. 5, the mobile terminal includes a receiving module 51 and a processing module 52, where the receiving module 51 is configured to receive application information sent by a set top box, where the application information is used to instruct the mobile terminal to obtain, using a web page server, a control UI for remote control on the set top box, and the application information carries address information of the control UI and connection information that is required by the mobile terminal for establishing a connection to the set top box using the web page server; and the processing module 52 is configured to establish, according to the connection information, the connection to the set top box using the web page server, and send, on the control UI according to the address information of the control UI, an operation instruction to the set top box using the web page server.

In this embodiment, a mobile terminal receives application information sent by a set top box, where the application information is used to instruct the mobile terminal to acquire a control UI for remote control on the set top box, the application information carries information about the control UI and connection information that is required by the mobile terminal for establishing a connection to the set top box using the web page server; then establishes, according to the connection information, the connection to the set top box using the web page server; and then sends, on the control UI according to address information of the control UI, an operation instruction to the set top box using the web page server, so that a relatively low-end mobile terminal can perform remote control on a set top.

On a basis of the foregoing embodiment, the receiving module 51 is further configured to receive the application update message sent by the set top box, where the application update message is used to update at least one of the address information of the control UI and the connection information.

FIG. 6 is a schematic structural diagram of another mobile terminal according to an embodiment of the present invention. As shown in FIG. 6, on a basis of the foregoing embodiment, the mobile terminal may further include a sending module 53, where the sending module 53 is configured to, after the application information sent by the set top box is received, acquire, using the web page server, the control UI for remote control on the set top box, and send, on the control UI, an operation instruction to the set top box using the web page server.

For a specific function of each module in the mobile terminal in FIG. 5 or in FIG. 6, reference may be made to description of the foregoing method embodiments.

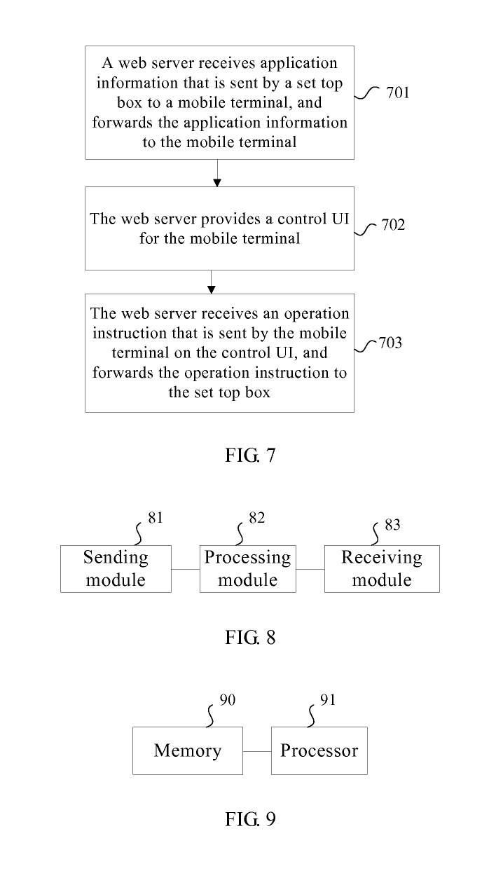

FIG. 7 is a schematic flowchart of still another terminal remote control method according to an embodiment of the present invention. As shown in FIG. 7, the terminal remote control method includes the following steps:

Step 701: A web page server receives application information that is sent by a set top box to a mobile terminal, and forwards the application information to the mobile terminal.

The application information in this embodiment is used to instruct the mobile terminal to acquire, using the web page server, a control UI for remote control on the set top box, the application information carries address information of the control UI and connection information that is required by the mobile terminal for establishing a connection to the set top box using the web page server, and the application information is information edited using a web page description language.

Step 702: The web page server provides a control UI for the mobile terminal.

Step 703: The web page server receives an operation instruction that is sent by the mobile terminal on the control UI, and forwards the operation instruction to the set top box.

In this embodiment, a web page server receives application information that is sent by a set top box to a mobile terminal, and forwards the application information to the mobile terminal; the web page server provides the control UI for the mobile terminal; and then the web page server receives an operation instruction that is sent by the mobile terminal on the control UI, and forwards the operation instruction to the set top box. Therefore, a remote control operation performed by the mobile terminal on the set top box is implemented, and the mobile terminal only needs to parse information edited in a web page description language, but does not need to decode video content of a television, which has a relatively low requirement for the mobile terminal, thereby implementing remote control on a set top box using a low and middle-end smart mobile terminal.

On a basis of the foregoing embodiment, before step 701, the terminal remote control method may further include the web page server receives information about the control UI sent by the set top box.

In this embodiment, the web page server is a network element that forwards an operation instruction to the mobile terminal, where the operation instruction is sent by the set top box.

Further, on the basis of the foregoing embodiment, that the web page server provides a control UI for the mobile terminal may include that the web page server provides the control UI for the mobile terminal according to the information about the control UI.

On the basis of the foregoing embodiment, after the web page server receives the application information that is sent by the set top box to the mobile terminal, and forwards the application information to the mobile terminal, the terminal remote control method may further include the web page server receives an application update message sent by the set top box, and forwards the application update message to the mobile terminal, where the application update message is used to update at least one of the address information of the control UI and the connection information.

FIG. 8 is a schematic structural diagram of a web page server according to an embodiment of the present invention. As shown in FIG. 8, the web page server includes a sending module 81, a processing module 82, and a receiving module 83, where the sending module 81 is configured to receive application information sent by a set top box to a mobile terminal, and forward the application information to the mobile terminal, where the application information is used to instruct the mobile terminal to acquire, using the web page server, a control UI for remote control on the set top box, the application information carries address information of the control UI and connection information that is required by the mobile terminal for establishing a connection to the set top box using the web page server, and the application information is information edited using a web page description language; and receive an operation instruction sent by the mobile terminal; the processing module 82 is configured to provide the control UI for the mobile terminal; and the receiving module 83 is configured to receive the operation instruction that is sent by the mobile terminal on the control UI, and forward the operation instruction to the set top box.

In this embodiment, a web page server receives application information that is sent by a set top box to a mobile terminal, and forwards the application information to the mobile terminal, then provides the control UI for the mobile terminal; and then, the web page server receives an operation instruction that is sent by the mobile terminal on the control UI, and forwards the operation instruction to the set top box. Therefore, a remote control operation performed by the mobile terminal on the set top box is implemented, and the mobile terminal only needs to parse information edited using a web page description language, but does not need to decode video content of a television, which has a relatively low requirement for the mobile terminal, thereby implementing remote control on a set top box using a low and middle-end smart mobile terminal.

On a basis of the foregoing embodiment, the receiving module 83 is further configured to receive information about the control UI sent by the set top box.

The processing module 82 is configured to provide the control UI for the mobile terminal according to the information about the control UI.

Further, on the basis of the foregoing embodiment, the sending module 81 is further configured to receive an application update message sent by the set top box, and forward the application update message to the mobile terminal, where the application update message is used to update at least one of the address information of the control UI and the connection information.

For a specific function of each module in the web page server, reference may be made to description of the foregoing method embodiments.

According to description of the foregoing implementation manners, persons skilled in the art can clearly understand that each implementation manner may be implemented using software in addition to a necessary hardware platform, and definitely may also be implemented using hardware. Based on such an understanding, the foregoing technical solutions essentially, or the part contributing to the prior art may be implemented in a form of a software product. The computer software product may be stored in a readable storage medium of a computer, such as a read-only memory (ROM), a random access memory (RAM), a magnetic disk, and an optical disk, and includes several instructions for instructing a computer device (which may be a personal computer, a server, a network device, or the like) to perform each embodiment or the methods described in some parts of the embodiments.

Further, the methods and solutions in the embodiments of the present invention are implemented in the form of the software product and stored in the readable storage medium of the computer, and may be also invoked by a processor unit simultaneously. FIG. 9 is a schematic structural diagram of another mobile terminal according to an embodiment of the present invention. As shown in FIG. 9, the schematic structural diagram of the terminal provided in the embodiment of the present invention corresponds to the method provided in the method embodiments, where the terminal includes a memory 90 configured to store information about a procedure; and a processor 91, connected to the memory 90 and configured to control execution of the procedure. The procedure may include sending application information to the mobile terminal, where the application information is used to instruct the mobile terminal to acquire, using a web page server, a control UI for remote control on a set top box, the application information carries address information of the control UI and connection information that is required by the mobile terminal for establishing a connection to the set top box using the web page server, and the application information is information edited using a web page description language; receiving an operation instruction that is sent by the mobile terminal on the control UI using the web page server; and performing an operation according to the operation instruction.

The procedure may also include receiving application information sent by a set top box, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; establishing, based on the connection information, the connection to the set top box using the web page server; and sending, on the control UI according to the address information of the control UI, an operation instruction to the set top box using the web page server.

The procedure may also include receiving application information that is sent by a set top box to the mobile terminal, and forwarding the application information to the mobile terminal, where the application information is used to instruct the mobile terminal to acquire, using a web page server, a control UI for remote control on the set top box, the application information carries address information of the control UI and connection information that is required by the mobile terminal for establishing a connection to the set top box using the web page server, and the application information is information edited using a web page description language; providing the control UI for the mobile terminal; and receiving an operation instruction that is sent by the mobile terminal on the control UI, and forwarding the operation instruction to the set top box.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A terminal remote control method comprising:
sending, by a set top box, application information to a mobile terminal, wherein the application information is used to instruct the mobile terminal to acquire, using a web page server, a control user interface UI for remote control on the set top box, wherein the application information carries address information of the control UI and connection information that is required by the mobile terminal for establishing a connection to the set top box using the web page server, and wherein the application information is information edited using a web page description language;
receiving, by the set top box, an operation instruction that is sent by the mobile terminal on the control UI using the web page server; and
performing, by the set top box, an operation according to the operation instruction.

2. The method according to claim 1, wherein before sending, by the set top box, the application information to the mobile terminal, the method further comprises:
generating, by the set top box, the control UI using the web page description language; and
sending, by the set top box, information about the control UI to the web page server, so as to enable the web page server to provide the control UI for the mobile terminal.

3. The method according to claim 1, wherein the set top box sends the application information to the mobile terminal in a broadcast manner.

4. The method according to claim 1, wherein after sending, by the set top box, the application information to the mobile terminal, the method further comprises sending, by the set top box, an application update message to the mobile terminal, wherein the application update message is used to update at least one of the address information of the control UI and the connection information.

5. A terminal remote control method comprising:
receiving, by a mobile terminal, application information sent by a set top box, wherein the application information is used to instruct the mobile terminal to obtain, using a web page server, a control user interface UI for remote control on the set top box, wherein the application information carries address information of the control UI and connection information that is required by the mobile terminal for establishing a connection to the set top box using the web page server, and wherein the application information is information edited using a web page description language;
establishing, by the mobile terminal according to the connection information, the connection to the set top box using the web page server; and
sending, by the mobile terminal according to the address information of the control UI and on the control UI, an operation instruction to the set top box using the web page server.

6. The method according to claim 5, wherein after receiving, by the mobile terminal, the application information sent by the set top box, the method further comprises receiving, by the mobile terminal, an application update message sent by the set top box, wherein the application update message is used to update at least one of the address information of the control UI and the connection information.

7. The method according to claim 5, wherein sending, by the mobile terminal according to the address information of the control UI and on the control UI, the operation instruction to the set top box using the web page server comprises:
acquiring, by the mobile terminal after receiving the application information sent by the set top box, the control UI using the web page server; and
sending, on the control UI, the operation instruction to the set top box using the web page server, wherein the control UI is used for remote control on the set top box.

8. A set top box comprising:
a sending module configured to send application information to a mobile terminal, wherein the application information is used to instruct the mobile terminal to acquire, using a web page server, a control user interface UI for remote control on the set top box, wherein the application information carries address information of the control UI and connection information that is required by the mobile terminal for establishing a connection to the set top box using the web page server, and wherein the application information is information edited using a web page description language;
a receiving module configured to receive an operation instruction that is sent by the mobile terminal on the control UI using the web page server; and
a processing module configured to perform an operation according to the operation instruction.

9. The set top box according to claim 8, wherein the processing module is further configured to generate the control UI using the web page description language, and wherein the sending module is further configured to send information about the control UI to the web page server, so as to enable the web page server to provide the control UI for the mobile terminal.

10. The set top box according to claim 8, wherein the sending module is further configured to send the application information to the mobile terminal in a broadcast manner.

11. The set top box according to claim 8, wherein the sending module is further configured to send an application update message to the mobile terminal, wherein the application update message is used to update at least one of the address information of the control UI and the connection information.

12. A mobile terminal comprising:
a receiving module configured to receive application information sent by a set top box, wherein the application information is used to instruct the mobile terminal to obtain, using a web page server, a control user interface UI for remote control on the set top box, and wherein the application information carries address information of the control user interface UI and connection information that is required by the mobile terminal for establishing a connection to the set top box using the web page server; and
a processing module configured to establish, according to the connection information, the connection to the set top box using the web page server; and send, on the control UI according to the address information of the control UI, an operation instruction to the set top box using the web page server.

13. The mobile terminal according to claim 12, wherein the receiving module is further configured to receive an application update message sent by the set top box, wherein the application update message is used to update at least one of the address information of the control UI and the connection information.

14. The mobile terminal according to claim 12, further comprising a sending module, wherein the sending module is configured to:
acquire, using the web page server, the control UI for remote control on the set top box after the application information sent by the set top box is received; and
send, on the control UI, the operation instruction to the set top box using the web page server.

15. A terminal remote control method comprising:
receiving, by a web page server, application information that is sent by a set top box to a mobile terminal;
forwarding the application information to the mobile terminal, wherein the application information is used to instruct the mobile terminal to acquire, using the web page server, a control user interface UI for remote control on the set top box, wherein the application information carries address information of the control UI and connection information that is required by the mobile terminal for establishing a connection to the set top box using the web page server, and wherein the application information is information edited using a web page description language;
providing, by the web page server, the control UI for the mobile terminal; and
receiving, by the web page server, an operation instruction that is sent by the mobile terminal on the control UI, and forwarding the operation instruction to the set top box.

16. The method according to claim 15, wherein before receiving, by the web page server, the application information that is sent by the set top box to the mobile terminal, the method further comprises receiving, by the web page server, information about the control UI sent by the set top box, and wherein providing, by the web page server, the control UI for the mobile terminal comprises providing, by the web page server, the control UI for the mobile terminal according to the information about the control UI.

17. The method according to claim 15, wherein after receiving, by the web page server, the application information that is sent by the set top box to the mobile terminal, and forwarding the application information to the mobile terminal, the method further comprises:
receiving, by the web page server, an application update message sent by the set top box; and
forwarding the application update message to the mobile terminal, wherein the application update message is used to update at least one of the address information of the control UI and the connection information.

18. A web page server comprising:
a sending module configured to receive application information that is sent by a set top box to a mobile terminal, and forward the application information to the mobile terminal, wherein the application information is used to instruct the mobile terminal to acquire, using the web page server, a control user interface UI for remote control on the set top box, wherein the application information carries address information of the control UI and connection information that is required by the mobile terminal for establishing a connection to the set top box using the web page server, and wherein the application information is information edited using a web page description language;
a processing module configured to provide the control UI for the mobile terminal; and
a receiving module configured to receive an operation instruction that is sent by the mobile terminal on the control UI, and forward the operation instruction to the set top box.

19. The web page server according to claim 18, wherein the receiving module is further configured to receive information about the control UI sent by the set top box, and wherein the processing module is further configured to provide the control UI for the mobile terminal according to the information about the control UI.

20. The web page server according to claim 18, wherein the sending module is further configured to:
receive an application update message sent by the set top box; and
forward the application update message to the mobile terminal, wherein the application update message is used to update at least one of the address information of the control UI and the connection information.
